(19) United States
(12) Patent Application Publication
(10) Pub. No.: US 2021/0301190 A1
(43) Pub. Date: Sep. 30, 2021

(54) REFRIGERANTS WITH REDUCED FLAMMABILITY PROFILE

(71) Applicant: Arkema Inc., King of Prussia, PA (US)

(72) Inventors: Laurent T. ABBAS, Ardmore, PA (US); George C. FORTMAN, Conshohocken, PA (US)

(21) Appl. No.: 17/346,367

(22) Filed: Jun. 14, 2021

Related U.S. Application Data
(63) Continuation of application No. 16/490,716, filed on Sep. 3, 2019, now abandoned.
(60) Provisional application No. 62/608,670, filed on Dec. 21, 2017.
(60) Provisional application No. 62/467,266, filed on Mar. 6, 2017.

(51) Int. Cl. C09K 5/04; F25B 9/00

(52) U.S. Cl. CPC C09K 5/045; F25B 9/006; C09K 2205/40; C09K 2205/126; C09K 2205/134; C09K 2205/122

(57) ABSTRACT

The present disclosure is directed to refrigerant compositions having reduced flammability profiles. The reduced flammability refrigerants comprise a refrigerant and an additive. Also disclosed are methods of increasing the minimum ignition energy of a refrigerant and methods of increasing the lower flammability limit of a refrigerant. The present disclosure is also directed to a method of scavenging radicals in a refrigerant.

This present application is a continuation of U.S. application Ser. No. 16/490,716 filed Sep. 3, 2019 which is the national phase under 35 USC § 371 of prior PCT International Application Number PCT/US2018/020875 filed Mar. 5, 2018 which designated the United States of America and claimed priority to U.S. Provisional Patent Application Ser. No. 62/608,670 filed Dec. 21, 2017 and U.S. Provisional Patent Application Ser. No. 62/467,266 filed Mar. 6, 2017

### FIELD

The present disclosure is related to refrigerant compositions with reduced flammability profiles and methods for reducing flammability in a refrigerant.

### BACKGROUND

Safety concerns currently limit the widespread adoption of flammable refrigerants for commercial and residential use. The selection of refrigerants for vapor compression HVAC&R systems requires tradeoffs between performance, safety, and environmental impact. The current generation of refrigerants such as R-410A and R-404A are typically composed of blends of flammable and non-flammable fluids in which the overall composition is classified as non-flammable. These refrigerants are intended to be near drop-in replacements for historically used single molecule fluids like R-11 and R-22. However, R-410A and R-404A have a high to very high global warming potential (GWP), and it has been difficult to find a refrigerant that is efficient, non-toxic, and non-flammable while also possessing a low GWP.

Most environmentally acceptable refrigerants are flammable and research to date has focused on adapting the design of refrigeration and air-conditioning systems to best handle flammable refrigerant fluids. These studies identified ways to mitigate the flammability by limiting the charge of refrigerants and/or designing the system with additional ventilation. None of these recent studies have focused on intrinsic ways to limit the flammability of the refrigerants without changing baseline refrigerant performance and GWP impact. Indeed, the traditional way to suppress the flammability of a refrigerant is to blend it with a known non-flammable refrigerant that has acceptable thermodynamic properties to generate a non-flammable blend. A current example is R-410A, a non-flammable blend of R-32 with a 2L classification and R-125 with a 1 classification. However, because R-125 has a high GWP, it can only be added in a small amount, which limits its potential to reduce flammability in blends with other flammable refrigerants.

Hydrofluorocarbons (HFCs) have replaced chlorofluorocarbons (CFCs) and hydrochlorofluorocarbons (HCFCs) as non-ozone depleting refrigerants for air-conditioning and refrigeration. However, some HFCs have Global Warming Potentials (GWPs) that are thousands of times greater than carbon dioxide and, as a result, their widespread use has come under increased scrutiny. Although industry has developing alternative refrigerants which do not deplete ozone and have low GWPs, these refrigerants are flammable and thus the size of the refrigerant charge is limited or the site of use is restricted to insure their safe use.

Because unsaturated fluorinated molecules like R-1234yf have a significantly different flammability profile than traditional flammable refrigerants like hydrocarbons and ammonia, the industry created a new classification, 2L to differentiate refrigerants based on their burning velocity. To be classified a 2L, a refrigerant needs to have a burning velocity of less than 0.1 m/s. In addition, the industry conducted risks assessments for using various flammable refrigerants in different applications, which led to modifications of safety standards like EN 378 or ASHRAE 15. The industry also partnered with several key institutions including DOE to better understand how to safely use and deploy flammable refrigerants. Although the safety standards are very complex, they seek to reduce the probability and severity of an event through new set of detection, ventilation or charge requirements.

### SUMMARY

In an effort to mitigate the safety risks of using non-ozone depleting, low GWP flammable refrigerants, Applicant proposes using additives to lower their flammability profile.

The present disclosure recites testing of molecules that lower the flammability profile of flammable refrigerants. In certain embodiments, these molecules can be used at an additive level (less than 0.6%) in the refrigerant and disrupt the combustion process.

Flame retardation or inhibition has been heavily investigated by the plastic industry in order to offer fire-protection for polymeric products or by aeronautics to suppress any fire. Many chemically active flame inhibitors have been described in the literature. The most promising molecules were based on a catalytic mode of inhibition and most of them can be found among the families of halogenated, organophosphates or organometallic molecules.

To date, a flammable refrigerant would only fall into two categories. If it can be blended with non-flammable refrigerant(s) to suppress its flammability it would fall in the category of blend component. If it can be used by itself because of very favorable thermodynamic properties, it would be categorized as flammable and its flammability characteristics would only depend on the nature of the refrigerant.

With this work, a third category is created that would favor the adoption of flammable refrigerants in the industry. By using flame inhibition additives, it is possible to modify the flammability characteristics of flammable refrigerants to help mitigate the risks associated with their use in air-conditioning and refrigeration system.

Besides answering the society's need for safety and low GWP, this approach could provide more tools to the industry to also meet efficiency requirements along the environmental obligations.

### DETAILED DESCRIPTION

Various examples and embodiments of the inventive subject matter disclosed here are possible and will be apparent to a person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there may be alternative embodiments which are not excluded.

The articles “a,” “an,” and “the” are used herein to refer to one or more than one (i.e., to at least one) of the grammatical object of the article. By way of example, “an element” means one element or more than one element.

As used herein, the term “about” means±10% of the noted value. By way of example only, a composition comprising “about 30 wt. %” of a compound could include from 27 wt. % of the compound up to and including 33 wt. % of the compound.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

As used herein, the term “lower flammability limit” (LFL) means minimum concentration of the refrigerant that is capable of propagating a flame through a homogeneous mixture of the refrigerant and air under the specified test conditions at 23.0° C. and 101.3 kPa.

As used herein, the term “minimum ignition energy” (MIE) means the minimum amount of energy required to ignite a combustible vapor for example by means of an electrostatic discharge.

As used herein, the term “burning velocity” (BV) means the velocity of a laminar flame under stated conditions of composition, temperature, and pressure

Applicant proposes to mitigate the effect of a leak of a mildly flammable (2L) refrigerant by using cost-effective additives to narrow the refrigerant's flammability window, reduce the minimum ignition energy (MIE), and/or lower the burning velocity of a refrigerant fire in order to reduce the probability and severity of an ignition event.

Reducing the flammability of Class 2L refrigerants enables their safe adoption in both existing and new HVAC&R systems; with the additional benefit that the refrigerant charge can be increased and shipping and handling costs can be reduced. Also, the mitigation strategy provides additional time to suppress the fire and evacuate persons from the immediate area. Embodiments of these additives will 1) not impact the toxicity classification of the refrigerant, 2) have a sufficiently high vapor pressure to be present in the refrigerant gas phase, 3) not decompose in thermo-mechanical cycling conditions used by the HVAC&R system, 4) have little to no degradation effects on the systems metal or plastic components such as corrosion or swelling, and/or 5) will not negatively impact the refrigerant stability. The effect of such additives can be useful on mildly flammable refrigerants like R-32, HFO-1234yf, blends containing R-32 and/or HFO-1234yf; compositions comprising the additives can be suitable for new as well as existing systems. The performance of refrigerants containing these additives can be tested in a commercial air-conditioning unit to confirm that the presence of additives does not negatively impact the system performance and operating conditions.

Applicant proposes a new way to reduce the overall flammability profile of Class 2L (and potentially Class 2 and 3) refrigerants by using radical scavenging additives such as organometallic, organophosporous, disulfides, halogenated sulfur molecules or dilution additives such as halogenated hydrocarbons or inert gas to enable low GWP refrigerants to be used in existing and new equipment designs. With the use of additives, it is possible to make R-1234yf based refrigerants non-flammable when tested at 23C per ASTM 681-09. This would lead to these refrigerants being classified as non-flammable by the U.S. Department of Transportation (and Global Harmonization System) and therefore facilitate their storage and transportation. In addition, a higher Minimum Ignition Energy (MIE) will have a direct impact on the risk assessment of the refrigerant in a vapor compression system. For example, embodiments of the present disclosure can increase the MIE of R-32 (30 mJ) blends by a factor of 1000 to reach a level similar to the unsaturated fluorocarbon R-1234ze. R-1234ze exhibits an MIE of about 60,000 mJ. Applicant uses radical scavengers or dilution additives to narrow the flammability window and increase the MIE. The present disclosure demonstrates that such additives used in 2L refrigerants can reduce the refrigerant's burning velocity to less than 0.02 m/s, close to the value of very low Global Warming Potential refrigerants like R-1234yf (0.015 m/s).

### Compositions

In certain embodiments, the present disclosure provides a refrigerant composition, comprising a refrigerant and a flammability-reducing additive.

In certain embodiments, the additive can be a radical scavenging additive. In certain embodiments, the additive can be an organometallic compound, an organophosphorus compound, an halogenated sulfur compound, a mono or multi sulfides compound, limonene oxide, Alpha-methylstyrene, Limonene oxide, p-methoxyphenol, 4-tert-butylcatechol or 2,6-di-tertbutylphenol. In certain embodiments, the additive can be an organometallic compound. In certain embodiments, the additive can be an organophosphorus compound. In certain embodiments, the additive can be an halogenated sulfur compound. In certain embodiments, the additive can be a disulfide compound. In certain embodiments, the additive can be limonene oxide. In certain embodiments, the additive can be Alpha-methylstyrene. In certain embodiments, the additive can be p-methoxyphenol. In certain embodiments, the additive can be 4-tert-butylcatechol. In certain embodiments, the additive can be 2,6-di-tertbutylphenol.

In certain embodiments, the additive can be a dilution additive. In certain embodiments, the additive can be an halogenated hydrocarbon compound, carbon dioxide or nitrogen

In certain embodiments, the additive can be an halogenated hydrocarbon compound. In certain embodiments, the additive can be carbon dioxide. In certain embodiments, the additive can be nitrogen.

Suitable organometallic compounds useful in the compositions of the present disclosure include any organometallic compound known in the art. Organometallic compounds generally have at least one bond between a carbon atom of an organic compound and a metal. The metal can be, e.g., alkaline, alkaline earth, and transition metals. Suitable organometallic compounds can also include transition metal hydrides and metal phosphine complexes.

Suitable organophosphorus compounds useful in the compositions of the present disclosure include any organophosphorus compound known in the art. Organophosphorus compounds are organic compounds containing phosphorus. Suitable organophosphorus compounds useful in the compositions of the present disclosure include, e.g., phosphate esters and amides; phosphonic and phosphinic acids and their esters; phosphine oxides, imides, and chalcogenides; phosphonium salts and phosphoranes; phosphites, phosphonites, and phosphinites; phosphines; and phosphaalkenes and phosphaalkynes.

Suitable halogenated sulfur compounds useful in the compositions of the present disclosure include any halogenated sulfur compound known in the art. Halogenated sulfur compounds are organic compounds containing at least one sulfur and one halogen atom.

Suitable disulfide compounds useful in the compositions of the present disclosure include any disulfide compound known in the art. Disulfide compounds are organic compounds containing a disulfide bond.

Suitable halogenated hydrocarbon useful in the compositions of the present disclosure include any halogenated hydrocarbon known in the art. Halogenated hydrocarbon compounds are organic compounds containing at least one halogen atom.

In certain embodiments, the refrigerant composition comprises one additive or at least one additive. In certain embodiments, the refrigerant composition comprises two additives or at least two additives. In certain embodiments, the refrigerant composition comprises three additives or at least three additives.

In certain embodiments, the composition comprises one or more organometallic compounds and one or more organophosphorus compounds.

In certain embodiments, the additive can be present in an amount between about 0.00001 wt. % to about 10 wt. %. In certain embodiments, the additive can be present in an amount between about 0.00001 wt. % to about 5 wt. %. In certain embodiments, the additive can be present in an amount between about 0.00001 wt. % to about 1 wt. %. In certain embodiments, the additive can be present in an amount between about 0.01 wt. % to about 1 wt. %. In certain embodiments, the additive can be present in an amount between about 0.01 wt. % to about 0.6 wt. %. In certain embodiments, the additive can be present in an amount between about 0.05 wt. % to about 0.6 wt. %. In certain embodiments, the additive can be present in an amount between about 0.1 wt. % to about 0.6 wt. %. In certain embodiments, the additive can be present in an amount between about 0.6 wt. % to about 2 wt. %. In In certain embodiments, the additive can be present in an amount of about 0.00001 wt. %, about 0.00005 wt. %, about 0.0001 wt. %, about 0.0005 wt. %, about 0.001 wt. %, about 0.005 wt. %, about 0.01 wt. %, about 0.05 wt. %, about 0.1 wt. %, about 0.15 wt. %, about 0.2 wt. %, about 0.25 wt. %, about 0.3 wt. %, about 0.35 wt. %, about 0.4 wt. %, about 0.45 wt. %, about 0.5 wt. %, about 0.55 wt. %, about 0.6 wt. %, about 0.65 wt. %, about 0.7 wt. %, about 0.85 wt. %, about 0.9 wt. %, about 0.95 wt. %, about 1 wt. %, about 2 wt. %, about 3 wt. %, about 4 wt. %, and about 5 wt. %, or any range between the specified values.

In certain embodiments, the refrigerant composition comprises one refrigerant. In certain embodiments, the refrigerant composition comprises two refrigerants or at least two refrigerants. In certain embodiments, the refrigerant composition comprises three refrigerants or at least three refrigerants.

In certain embodiments, the refrigerant is a Class 2L, Class 2, or Class 3 refrigerant. In certain embodiments, the refrigerant is a Class 2L refrigerant. In certain embodiments, the refrigerant is a Class 2 refrigerant. In certain embodiments, the refrigerant is a Class 3 refrigerant.

Refrigerant classes are set by standardization organizations and/or international treaties, such as the International Organization for Standardization or the Montreal Protocol. ISO 817:2014 defines specific refrigerant classes. Class 1 refrigerants are non-combustible or do not support the spread of a flame in a combustible environment. Class 2L refrigerants have a LFL greater than 100 g/m³, a heat of combustion (HOC) of less than 19,000 kJ/kg, and a burning velocity of less than 0.1 m/s. Class 2 refrigerants have a LFL greater than 100 g/m³ and a heat of combustion of less than 19,000 kJ/kg. Class 3 refrigerants have LFL less than 100 g/m³ and a heat of combustion of greater than 19,000 kJ/kg.

In certain embodiments, the present disclosure provides a refrigerant composition, comprising a refrigerant and an additive, wherein the composition has a LFL greater than 100 g/m³ and/or a heat of combustion of less than 19,000 kJ/kg, and wherein the refrigerant has a LFL less than 100 g/m³ and/or a heat of combustion of greater than 19,000 kJ/kg. In certain embodiments, the composition can have a LFL greater than at least about 5%, at least about 10%, at least about 15%, at least about 20%, at least about 25%, at least about 30%, at least about 35%, at least about 40%, at least about 45%, and at least about 50%, or any range between the specified values, the LFL of the refrigerant. In certain embodiments, the composition can have a heat of combustion less than at least about 5%, at least about 10%, at least about 15%, at least about 20%, at least about 25%, at least about 30%, at least about 35%, at least about 40%, at least about 45%, and at least about 50%, or any range between the specified values, the heat of combustion of the refrigerant.

In certain embodiments, the present disclosure provides a refrigerant composition, comprising a refrigerant and an additive, wherein the composition has a LFL greater than 100 g/m³, a HOC of less than 19,000 kJ/kg, and/or a burning velocity of less than 0.1 m/s, and wherein the refrigerant has a LFL less than 100 g/m³, a HOC of greater than 19,000 kJ/kg, and/or a burning velocity of greater than 0.1 m/s. In certain embodiments, the composition can have a LFL greater than at least about 5%, at least about 10%, at least about 15%, at least about 20%, at least about 25%, at least about 30%, at least about 35%, at least about 40%, at least about 45%, and at least about 50%, or any range between the specified values, the LFL of the refrigerant. In certain embodiments, the composition can have a HOC less than at least about 5%, at least about 10%, at least about 15%, at least about 20%, at least about 25%, at least about 30%, at least about 35%, at least about 40%, at least about 45%, and at least about 50%, or any range between the specified values, the heat of combustion of the refrigerant. In certain embodiments, the composition can have a burning velocity of less than at least about 5%, at least about 10%, at least about 15%, at least about 20%, at least about 25%, at least about 30%, at least about 35%, at least about 40%, at least about 45%, and at least about 50%, or any range between the specified values, the burning velocity of the refrigerant.

In certain embodiments, the present disclosure provides a refrigerant composition, comprising a refrigerant and an additive, wherein the composition is non-combustible and/or does not support the spread of a flame in a combustible environment, and wherein the refrigerant is combustible and/or does support the spread of a flame in a combustible environment. In certain embodiments, the refrigerant can be a Class 2L, a Class 2, or a Class 3 refrigerant.

In certain embodiments, the present disclosure provides a refrigerant composition, comprising a refrigerant and an additive, wherein the composition has a burning velocity of less than 0.02 m/s, and wherein the refrigerant has a burning velocity of greater than 0.02 m/s. In certain embodiments, the present disclosure provides a refrigerant composition, comprising a refrigerant and an additive, wherein the composition is a class 1, 2L, or 2 refrigerant, and wherein the refrigerant is a class 3 refrigerant. In certain embodiments, the present disclosure provides a refrigerant composition, comprising a refrigerant and an additive, wherein the composition is a class 1 or 2L refrigerant, and wherein the refrigerant is a class 2 refrigerant. In certain embodiments, the present disclosure provides a refrigerant composition, comprising a refrigerant and an additive, wherein the composition is a class 1 refrigerant, and wherein the refrigerant is a class 2L refrigerant.

Suitable refrigerants include any refrigerant known in the art. Suitable refrigerants can include one or more hydrohaloolefins of Formula I below:

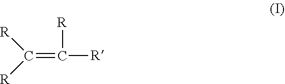

where each R is independently Cl, F, Br, I or H; R′ is (CR2)nY; Y is CRF2; and n is 0, 1, 2 or 3, preferably 0 or 1. In highly preferred embodiments, Y is CF3, n is 0 or 1 (most preferably 0) and at least one of the remaining Rs is F.

Suitable refrigerants can include hydrocarbons, chlorocarbons, chlorofluorocarbons, hydrochlorofluorocarbons, hydrofluorocarbons, perfluorocarbons, fluoroethers, HFPO, SF₆, chlorine, hexafluoroacetone, and mixtures thereof.

Suitable refrigerants can include:
R-32—difluoromethane, or CH₂F₂
HCC-40: chloromethane, or CH₃Cl
HCFC-115: chloropentafluoroethane, or C₂F₅Cl
HCFC-124: chlorotetrafluoroethane, or C₂HF₄Cl
HFC-125: pentafluoroethane, or C₂HF₅
HCFC-133a: 1-chloro-2,2,2-trifluoroethane, or C₂H₂F₃Cl
HFC-134a: 1,1,1,2-tetrafluoroethane, or C₂H₂F₄
HFC-134: 1,1,2,2-tetrafluoroethane, or C₂H₂F₄
HCFC-142b: 1-chloro-1,1-difluoroethane, or C₂H₃F₂Cl
HFC-143a: 1,1,1-trifluoroethane, or C₂H₃F₃
HFC-152a: 1,1-difluoroethane, or C₂H₄F₂
HFO-1132: 1,2-difluoroethylene, or C₂H₂F₂
HFO-1141: fluoroethylene, or C₂H₃F
HFO-1234yf: 2,3,3,3-tetrafluoropropene or CH₂═CF—CF₃
HFC-245cb: 1,1,1,2,2-pentafluoropropane or CF₃—CF₂—CH₃
HFO-1234zeE: E-1,3,3,3-tetrafluoropropene or E-CF₃—CH═CHF
HFO-1234zeZ: Z-1,3,3,3-tetrafluoropropene or Z—CF₃—CH═CHF
HFO-1243zf: 3,3,3-trifluoropropene or CF₃—CH═CH₂
HCFO-1233xf: 3,3,3-trifluoro-2-chloropropene or CF₃—CCl═CH₂
HCFO-1233zdE: E-3,3,3-trifluoro-1-chloropropene or E-CF₃—CH═CHCl
HCFO-1233zdZ: Z-3,3,3-trifluoro-1-chloropropene or Z—CF₃—CH═CHCl
HFO-1225yeZ: Z-1,1,1,2,3-pentafluoropropene or Z—CHF═CF—CF₃
HFO-1225yeE: E-1,1,1,2,3-pentafluoropropene or E-CHF═CF—CF₃
HFO-1225zc: 1,1,3,3,3-pentafluoropropene or CF₂═CH—CF₃
HFO-1225yc: 1,1,2,3,3-pentafluoropropene or CF₂═CF—CF₂
HCFC-1214: dichlorotetrafluoropropene, or C₃F₄Cl₂
HCFO-1215: chloropentafluoropropene, or C₃F₅Cl
HFO-1216: hexafluoropropene, or C₃F₆
HCFO-1223: dichlorotrifluoropropene, or C₃HF₃Cl₂
HCFO-1224: chlorotetrafluoropropene, or C₃HF₄Cl
HCFO-1232: dichlorodifluoropropene, or C₃H₂F₂Cl₂
HCFO-1233xc: 1,1,3-trifluoro-2-chloropropene or CH₂F—CCl═CF₂
HCFO-1233xe: 1,3,3-trifluoro-2-chloropropene or CHF₂—CCl═CHF
HCFO-1233yb: 1,2,3-trifluoro-1-chloropropene or CH₂F—CF═CFCl
HCFO-1233yc: 1,1,2-trifluoro-3-chloropropene or CH₂Cl—CF═CF₂
HCFO-1233yd: 2,3,3-trifluoro-1-chloropropene or CHF₂—CF═CHCl
HCFO-1233ye: 1,2,3-trifluoro-3-chloropropene or CHClF—CF═CHF
HCFO-1233yf: 2,3,3-trifluoro-3-chloropropene or CClF₂—CF═CH₂
HCFO-1233zb: 1,3,3-trifluoro-1-chloropropene or CHF₂—CH═CFCl
HCFO-1233zc: 1,1,3-trifluoro-3-chloropropene or CHClF—CH═CF₂
HCFO-1233ze: 1,3,3-trifluoro-3-chloropropene or CClF₂—CH═CHF
HFO-1234yc: 1,1,2,3-tetrafluoropropene or CF₂═CF—CH₂F
HFO-1234ye: 1,2,3,3-tetrafluoropropene or CHF═CF—CHF₂
HFO-1234zc: 1,1,3,3-tetrafluoropropene or CF₂═CH—CHF₂
HCFO-1242: chlorodifluoropropene, or C₃H₃F₂Cl
HFO-1243yc: 1,1,2-trifluoropropene or CH₃—CF═CF₂
HFO-1243ye: 1,2,3-trifluoropropene or CH₂F—CF═CHF
HFO-1243yf: 2,3,3-trifluoropropene or CHF₂—CF═CH₂
HFO-1243zc: 1,1,3-trifluoropropene or CH₂F—CH═CF₂
HFO-1243ze: 1,3,3-trifluoropropene or CHF₂—CH═CHF
HCFO-1251: chlorofluoropropene, or C₃H₄FCl
HFO-1252: difluoropropene, or C₃H₄F₂
HFO-216: hexafluoropropene, or C₃F₆Cl₂
HCFO-217: chloroheptafluoropropane, or C₃F₇Cl
HFC-218: octafluoropropane, or C₃F₈
HCFC-225: dichloropentafluoropropane, or C₃HF₅Cl₂
HCFC-226: chlorohexafluoropropane, or C₃HF₆Cl
HFC-227: heptafluoropropane, or C₃HF₂
HCFC-234: dichlorotetrafluoropropane, or C₃H₂F₄Cl₂
HCFC-235: chloropentafluoropropane, or C₃H₂F₅Cl
HFC-236: hexafluoropropane, or C₃H₂F₆
HCFC-243: dichlorotrifluoropropane, or C₃H₃F₃Cl₂
HCFC-244: chlorotetrafluoropropane, or C₃H₃F₄Cl
HCFC-244bb: 2-chloro,1,1,1,2-tetrafluoropropane or CF₃—CFCl—CH₃
HFC-245fa: 1,1,1,3,3-pentafluoropropane or CF₃—CH₂—CHF₂
HFC-245ea: 1,1,2,3,3-pentafluoropropane or CHF₂—CHF-CHF₂
HFC-245eb: 1,1,1,2,3-pentafluoropropane or CF₃—CHF—CH₂F
HFC-245ca: 1,1,2,2,3-pentafluoropropane or CHF₂—CF₂—CH₂F
HCFC-253: chlorotrifluoropropane, or C₃H₄F₃Cl
HFC-254: tetrafluoropropane, or C₃H₄F₄
HCFC-262: Chlorodifluoropropane, or C₃H₅F₂Cl
HFC-263: trifluoropropane, or C₃H₅F₃ and
Trifluoropropyne: CF₃—C≡CH

In certain embodiments, the refrigerant comprises one or more of R-32, HFO-1234yf, HFO-1234ze, and HFC-143a, and mixtures thereof. In certain embodiments, the refrigerant can be R-32. In certain embodiments, the refrigerant can be HFO-1234yf. In certain embodiments, the refrigerant can be HFO-1234ze. In certain embodiments, the refrigerant can be HFC-143a.

### Methods

In certain embodiments, the present disclosure provides a method of increasing the minimum ignition energy of a refrigerant, comprising adding an additive to a refrigerant.

In certain embodiments, the present disclosure provides a method of increasing the lower flammability limit of a refrigerant, comprising adding an additive to a refrigerant.

In certain embodiments, the present disclosure provides a method of scavenging a radical in a refrigerant, comprising adding an additive to a refrigerant.

In certain embodiments, the present disclosure provides a method of inhibiting a chemically active flame in a refrigerant composition, comprising adding an additive to a refrigerant, wherein the additive scavenges radical species.

In certain embodiment, the present disclosure provides a method of lowering the flammability of a refrigerant composition, comprising adding an additive to a refrigerant, wherein the additive dilutes the flammable refrigerant.

Aspect 1: A refrigerant composition, comprising a refrigerant and a flammability-reducing additive.
Aspect 2: The composition according to aspect 1, wherein the additive is a radical scavenging additive.
Aspect 3: The composition of aspect 1, wherein the additive is a dilution additive.
Aspect 4: The composition of aspect 1, wherein the additive is a halogenated hydrocarbon compound.
Aspect 5: The composition according to any one of aspects 1 or 2, wherein the additive is an organometallic compound, an organophosphorus compound, a halogenated sulfur compound, or a mono or multi sulfides compound.
Aspect 6: The composition according to any one of aspects 1 or 2, wherein the additive is limonene oxide, Alpha-methylstyrene, p-methoxyphenol, 4-tert-butylcatechol or 2,6-di-tertbutylphenol.
Aspect 7: The composition according to any one of aspects 1-6, wherein the composition comprises at least two additives.
Aspect 8: The composition according to any one of aspects 1-7, wherein the composition comprises at least three additives.
Aspect 9: The composition according to any one of aspects 1-8, wherein the composition comprises at least two refrigerants.
Aspect 10: The composition according to any one of aspects 1-9, wherein the composition comprises at least three refrigerants.
Aspect 11: The composition according to any one of aspects 1-10, wherein the refrigerant is a Class 2L, Class 2, or Class 3 refrigerant.
Aspect 12: The composition according to any one of aspects 1-11, wherein the refrigerant is a Class 2L refrigerant.
Aspect 13: The composition according to any one of aspects 1-11, wherein the refrigerant comprises one or more of R-32, HFO-1234yf, HFO-1234ze, and HFC-143a, and mixtures thereof.
Aspect 14: The composition according to any one of aspects 1-13, wherein the composition comprises one or more organometallic compounds and one or more organophosphorus compounds.
Aspect 15: The composition according to any one of aspects 1-14, wherein the additive is present in an amount between about 0.00001 wt. % to about 5 wt. %.
Aspect 16: The composition according to any one of aspects 1-15, wherein the additive is present in an amount between about 0.00001 wt. % to about 1 wt. %.
Aspect 17: The composition according to any one of aspects 1-16, wherein the additive is present in an amount between about 0.01 wt. % to about 1 wt. %.
Aspect 18: The composition according to any one of aspects 1-17, wherein the additive is present in an amount between about 0.1 wt. % to about 0.6 wt. %.
Aspect 19: The composition according to any one of aspects 1-16, wherein the additive is present in an amount between about 0.6 wt. % to about 2 wt. %.
Aspect 20: A method of scavenging a radical in a refrigerant, comprising adding an additive to a refrigerant.
Aspect 21: A method of inhibiting a chemically active flame in a refrigerant composition, comprising adding an additive to a refrigerant, wherein the additive scavenges radical species.
Aspect 22: A refrigerant composition, comprising a refrigerant and an additive, wherein the composition has a lower flammability limit (LFL) that is at least 10% greater than the lower flammability limit of the refrigerant.
Aspect 23: The composition according to aspect 22, wherein the composition has a LFL that is at least 15% greater than the LFL of the refrigerant.
Aspect 24: The composition according to any one of aspects 22 or 23, wherein the composition has a LFL that is at least 20% greater than the LFL of the refrigerant.
Aspect 25: The composition according to any one of aspects 22-24, wherein the composition has a LFL that is at least 30% greater than the LFL of the refrigerant.
Aspect 26: The composition according to any one of claims 22-25, wherein the composition has a LFL that is at least 40% greater than the LFL of the refrigerant.
Aspect 27: The composition according to any one of aspects 22-26, wherein the composition has a LFL that is at least 20% greater than the LFL of the refrigerant.
Aspect 28: A refrigerant composition, comprising a refrigerant and an additive, wherein the composition has a burning velocity of less than 0.02 m/s, and wherein the refrigerant has a burning velocity of greater than 0.02 m/s.
Aspect 29: The composition according to aspect 28, wherein the composition has a burning velocity of less than 0.015 m/s, and wherein the refrigerant has a burning velocity of greater than 0.02 m/s.
Aspect 30: The composition according to any one of aspects 28 or 29, wherein the composition has a burning velocity of less than 0.01 m/s, and wherein the refrigerant has a burning velocity of greater than 0.02 m/s.
Aspect 31: The composition according to any one of aspects 28-30, wherein the composition has a burning velocity of less than 0.005 m/s, and wherein the refrigerant has a burning velocity of greater than 0.02 m/s.

What is claimed is:

1. A refrigerant composition, comprising a refrigerant and a flammability-reducing additive.

2. The composition according to claim 1, wherein the additive is a radical scavenging additive.

3. The composition of claim 1, wherein the additive is a dilution additive.

4. The composition of claim 1, wherein the additive is a halogenated hydrocarbon compound.

5. The composition according to claim 1, wherein the additive is an organometallic compound, an organophosphorus compound, a halogenated sulfur compound, or a mono or multi sulfides compound.

6. The composition according to claim 1, wherein the additive is limonene oxide, Alpha-methylstyrene, p-methoxyphenol, 4-tert-butylcatechol or 2,6-di-tertbutylphenol.

7. The composition according to claim 1, wherein the composition comprises at least two additives.

8. The composition according to claim 1, wherein the composition comprises at least three additives.

9. The composition according to claim 1, wherein the composition comprises at least two refrigerants.

10. The composition according to claim 1, wherein the composition comprises at least three refrigerants.

11. The composition according to claim 1, wherein the refrigerant is a Class 2L, Class 2, or Class 3 refrigerant.

12. The composition according to claim 1, wherein the refrigerant is a Class 2L refrigerant.

13. The composition according to claim 1, wherein the refrigerant comprises one or more of R-32, HFO-1234yf, HFO-1234ze, and HFC-143a, and mixtures thereof.

14. The composition according to claim 1, wherein the composition comprises one or more organometallic compounds and one or more organophosphorus compounds.

15. The composition according to claim 1, wherein the additive is present in an amount between about 0.00001 wt. % to about 5 wt. %.

16. The composition according to claim 1, wherein the additive is present in an amount between about 0.00001 wt. % to about 1 wt. %.

17. The composition according to claim 1, wherein the additive is present in an amount between about 0.01 wt. % to about 1 wt. %.

18. The composition according to claim 1, wherein the additive is present in an amount between about 0.1 wt. % to about 0.6 wt. %.

19. The composition according to claim 1, wherein the additive is present in an amount between about 0.6 wt. % to about 2 wt. %.

20. A method of scavenging a radical in a refrigerant, comprising adding an additive to a refrigerant.

21. A method of inhibiting a chemically active flame in a refrigerant composition, comprising adding an additive to a refrigerant, wherein the additive scavenges radical species.

22. A refrigerant composition, comprising a refrigerant and an additive, wherein the composition has a lower flammability limit (LFL) that is at least 10% greater than the lower flammability limit of the refrigerant.

23. The composition according to claim 22, wherein the composition has a LFL that is at least 15% greater than the LFL of the refrigerant.

24. The composition according to claim 22, wherein the composition has a LFL that is at least 20% greater than the LFL of the refrigerant.

25. The composition according to claim 22, wherein the composition has a LFL that is at least 30% greater than the LFL of the refrigerant.

26. The composition according to claim 22, wherein the composition has a LFL that is at least 40% greater than the LFL of the refrigerant.

27. A refrigerant composition, comprising a refrigerant and an additive, wherein the composition has a burning velocity of less than 0.02 m/s, and wherein the refrigerant has a burning velocity of greater than 0.02 m/s.

28. The composition according to claim 27, wherein the composition has a burning velocity of less than 0.015 m/s, and wherein the refrigerant has a burning velocity of greater than 0.02 m/s.

29. The composition according to claim 27, wherein the composition has a burning velocity of less than 0.01 m/s, and wherein the refrigerant has a burning velocity of greater than 0.02 m/s.

30. The composition according to claim 27, wherein the composition has a burning velocity of less than 0.005 m/s, and wherein the refrigerant has a burning velocity of greater than 0.02 m/s.
